(19) United States
(12) Patent Application Publication
(10) Pub. No.: US 2003/0147185 A1
(43) Pub. Date: Aug. 7, 2003

(54) Degater having movable support pins

(76) Inventors: Mariano P. Regala IV, Angono (PH); Ruel B. Pieda, Bacoor (PH)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/061,688

(22) Filed: Feb. 1, 2002

(51) Int. Cl. B26D 1/00; B26D 3/00

(52) U.S. Cl. 361/1; 83/13

(57) ABSTRACT

A degater is described having upper and lower support halves movable relative to one another between an open position and a closed position. The support halves, while in the closed position, secure an encapsulated microelectronic device having excess encapsulant attached thereto and being partially severable therefrom. The upper support half includes a retainer for securing the excess encapsulant when in the closed position and for detaching the excess encapsulant from the encapsulated device when the support halves move to the open position. The upper support half also includes movable support pins which contact the encapsulated device when the support halves are in the closed position, and bias the encapsulated device against the lower support half as the support halves move from the closed to the open position.

### BACKGROUND OF THE INVENTION

1). Field of the Invention

This invention relates to a degater for removing excess encapsulant from a microelectronic device having encapsulant formed thereon.

2. Disussion of Related Art

In a process for fabricating microelectronic device packages, microelectronic devices are encapsulated with a molding compound (e.g., an epoxy resin) in order to provide protection of the microelectronic device from external environments. This encapsulation process is also called a molding process.

The encapsulation process involves placing microelectronic devices, typically positioned on a substrate or leadframe, in one or more cavities of a mold. Liquid molding compound is then forced through chambers of a mold, forming culls, and subsequently flows through a series of mold runners and subrunners. From the subrunners, the mold compound flows through a series of gates and enters the mold cavities, thus forming encapsulant bodies on the microelectronic devices. Excess encapsulant, a byproduct of the encapsulation process, is ejected from the runners and subrunners while still connected to the gates of the encapsulant bodies. Excess encapsulant can be removed by a process called degating with the aid of an apparatus called a “degater.”

The purpose of degating is to remove the excess encapsulant from the encapsulant bodies protecting the microelectronic device. Degating is typically accomplished by a series of supports of the degater securing the encapsulated microelectronic device while another series of supports of the degater secures and detaches the excess encapsulant from the encapsulant bodies. Detaching the excess encapsulant from the encapsulant bodies without damaging the encapsulant can be difficult to accomplish because of possible damage to the microelectronic device packages.

### BRIEF DESCRIPTION OF THE DRAWINGS

The invention is described by way of example with reference to the accompanying drawings wherein:

FIG. 1 is a cross-sectional front view of a degater assembly including an electronic assembly with encapsulant formed thereon;

FIG. 2 is a bottom view of an upper degater half;

FIG. 3 is a top view of a lower degater half;

FIG. 4 is a top view of the electronic assembly;

FIG. 5 is a side view of the electronic assembly;

FIG. 6 is a top view of the lower degater half and the electronic assembly in combination;

FIG. 7 is a cross-sectional view of a support pin assembly;

FIG. 8 is a cross-sectional view of the degater including the upper degater half, lower degater half, and electronic assembly in combination;

FIG. 9 is a view similar to FIG. 8 showing the upper and lower degater halves in a closed position;

FIG. 10 is a view similar to FIG. 9, showing the upper and lower degater halves in a butterfly position;

FIG. 11 is a view similar to FIG. 10, showing the upper and lower degater halves separated from each other with support pins still contacting the electronic assembly;

FIG. 12 is a view similar to FIG. 11, showing the upper and lower degater halves completely separated from each other with the support pins clear from the electronic assembly;

FIG. 13 is an enlarged, cross-sectional view of the support pin assembly with the support pin in the retracted position; and

FIG. 14 is an enlarged, cross-sectional view of a support pin assembly with the support pin in the extended position contacting a surface of the electronic assembly.

### DETAILED DESCRIPTION OF THE INVENTION

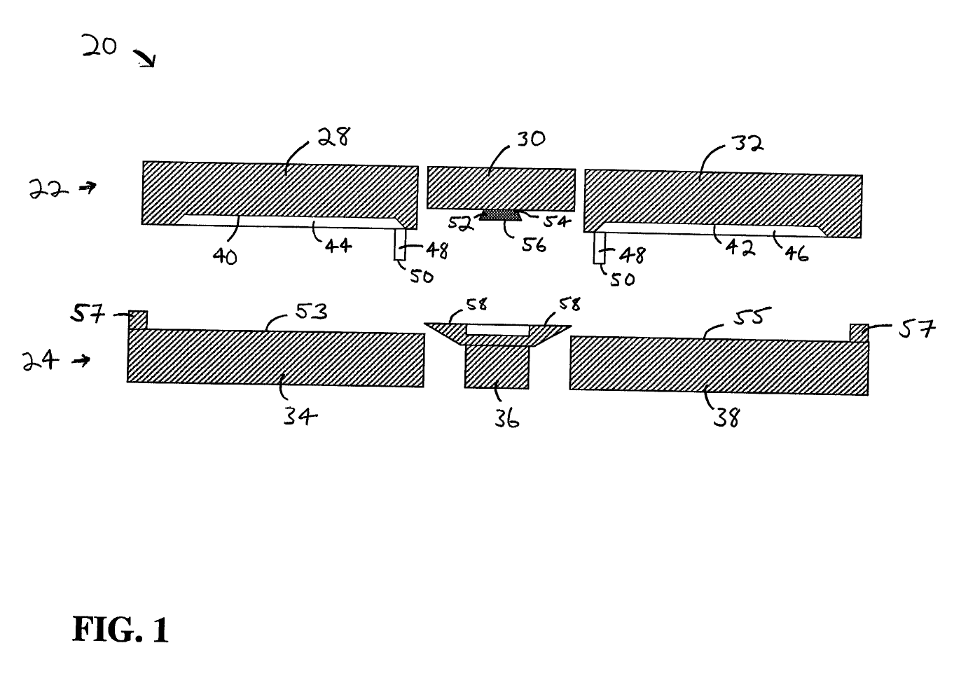

FIG. 1 of the accompany drawings illustrates components of a degater assembly 20 according to one embodiment of the invention, including an upper degater half 22 and a lower degater half 24. The upper degater half 22 and the lower degater half 24 are positionable over each other with the aid of a guide rod assembly (not shown).

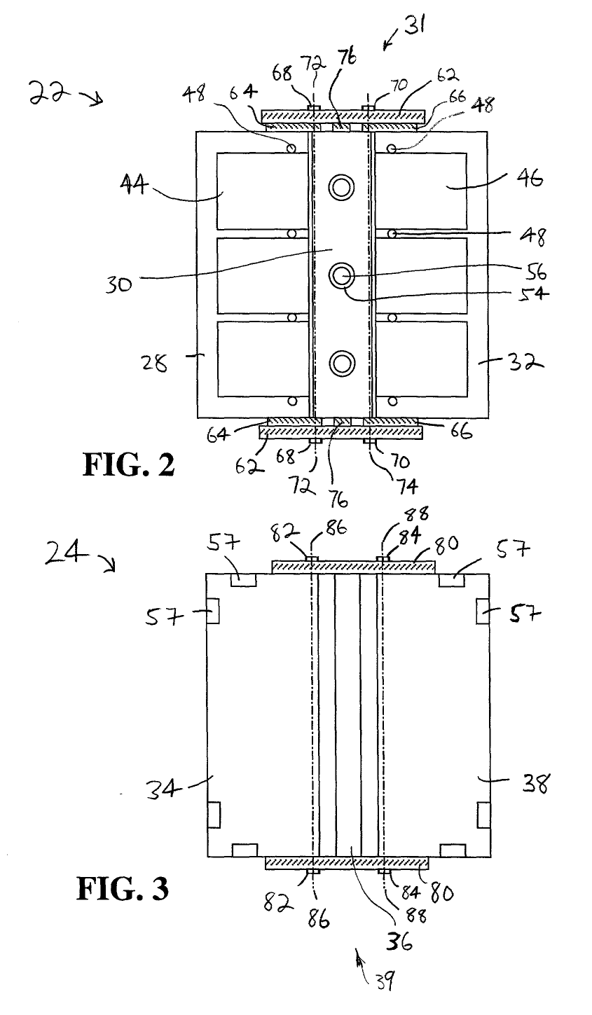

The upper degater half 22 includes a left upper support 28, an upper cull support 30, and a right upper support 32. Referring to FIG. 2, the upper supports 28 and 32 are connected to upper cull support 30 by an upper hinge assembly 31, which allows the upper supports 28 and 32 to pivot relative to the upper cull support 30.

Lower degater half 24 includes a left lower support 34, a lower cull support 36, and a right lower support 38. Referring to FIG. 3, the lower supports 34 and 38 are connected to the lower cull support 36 by lower hinge assembly 39, which allows the lower supports 34 and 38 to pivot relative to the lower cull support 36. Each of the above supports is made from steel but may be made from another metal in another embodiment.

The upper supports 28 and 32 have lower surfaces 40 and 42, respectively, and the lower surfaces 40 and 42 are recessed to form volumes 44 and 46, respectively. The upper supports 28 and 32 each includes support pins 48 having bottom surfaces 50. Support pins 48 are made from steel, but may, in another embodiment, be made from a similar metal or from a rigid plastic. The upper cull support 30 includes a plurality of retainers 52 behind one another, looking into FIG. 1. Each retainer 52 has an upper portion 54 and a lower portion 56. The upper portion 54 is secured to the upper cull support 30. The lower portion 56 is shaped in the form of a cup and is made from a flexible rubber material.

The lower supports 34 and 38 have upper surfaces 53 and 55, respectively. The lower supports 34 and 38 include lateral aligning supports 57. The aligning supports 57 are bolted to sides of lower supports 34 and 38 and protrude upwardly from outer extremities of the upper surfaces 53 and 55. The lower cull support 36 has an upper surface 58, which is positioned parallel and slightly higher than the upper surfaces 53 and 55.

Referring to FIG. 2 specifically, the upper hinge assembly 31 includes hinge plates 62, hinge arms 64 and 66, and hinge pins 68 and 70. The upper supports 28 and 32 are bolted to the hinge arms 64 and 66 respectively. The hinge arms 64 and 66 are secured to the hinge plates 62 by the hinge pins 68 and 70. The hinge arms 64 can freely pivot about axis 72, thus allowing the upper support 28 to pivot relative to axis 72. Similarly, the hinge arms 66 can freely pivot about an axis 74, thus allowing the upper support 32 to pivot relative to axis 74. The upper cull support 30 is bolted to spacers 76, and each of the spacers 76 is bolted to a respective one of the hinge plates 62.

Referring to FIG. 3 specifically, the lower hinge assembly 39 includes hinge plates 80 and hinge pins 82 and 84. The lower supports 34 and 38 are secured to the hinge plates 80 by the hinge pins 82 and 84. The lower support 34 can freely pivot about an axis 86, and the lower support 38 can freely pivot about an axis 88. The lower cull support 36 is bolted to and between the hinge plates 80.

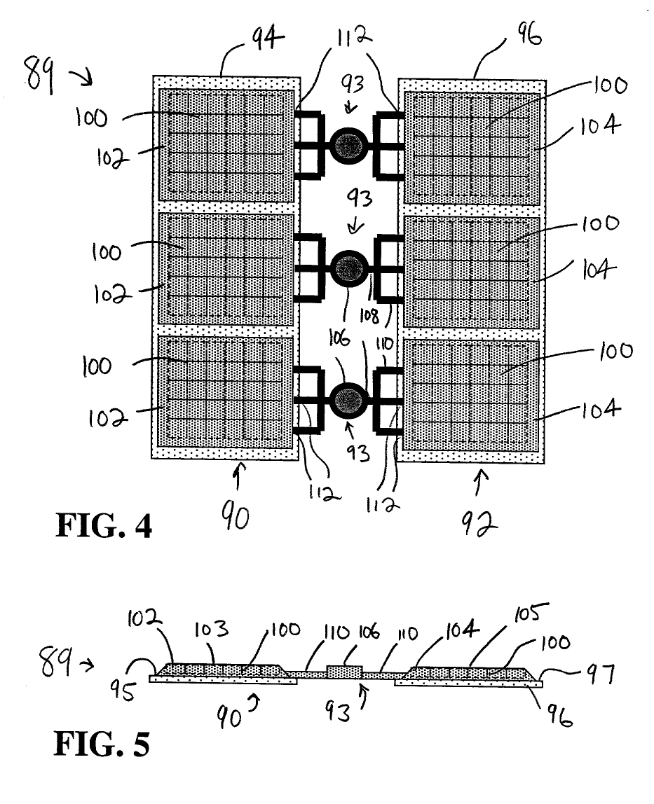

FIGS. 4, 5, and 6 illustrate electronic assembly 89, including electronic subassemblies 90 and 92 and excess encapsulant pieces 93. The subassemblies 90 and 92 include substrates 94 and 96, pluralities of electronic chips 100 (see FIG. 5), and encapsulant bodies 102 and 104. The substrates 94 and 96 contain bismaleimide triazine and are typically referred to as “BT Cores.” The substrates 94 and 96, having top surfaces 95 and 97 respectively, include pluralities of wirebonded interconnect units formed thereon (not shown). Each interconnect unit has a silicon die (not shown) electronically attached thereon, and a combination of an interconnect unit and a silicon die represents one chip of the electronic chips 100. Therefore, the substrates 94 and 96 each include a plurality of chips 100. Each plurality of chips 100 is encapsulated in an encapsulant body, e.g., 102 or 104. The encapsulant bodies 102 and 104 and the excess encapsulant pieces 93 are made from an epoxy resin. The epoxy resin covers all open sides of the silicon dies attached to substrates 94 and 96. Alternatively, if the dies are molded using a leadframe instead of substrate strips, the epoxy resin can completely encapsulate all sides of the silicon dies, except for outwardly protruding leads attached to the dies. When a leadframe is used during the molding process, each die is not attached to a common substrate. Rather, each die is independently supported by the leadframe, thus allowing molding compound to completely cover all sides of the die.

Excess encapsulant pieces 93 connect encapsulant bodies 102 to encapsulant bodies 104. Particularly, subrunners 110 of encapsulant pieces 93 are integrally connected to encapsulant bodies 102 and 104 at gates 112. Furthermore, a cull 106 joins the subrunners 110 together for each pair of encapsulant bodies 102 and 104. The gates 112 represent regions where, during an encapsulation process, encapsulant material flows from mold runners and subrunners into a mold cavity, thus forming the encapsulant bodies 102 and 104. In addition, it is possible that subrunners 110 of encapsulant pieces 102 become adhesively secured to portions of the substrates 94 and 96 as a result of the subrunners 110, prior to curing, contacting surfaces of substrates 94 and 96.

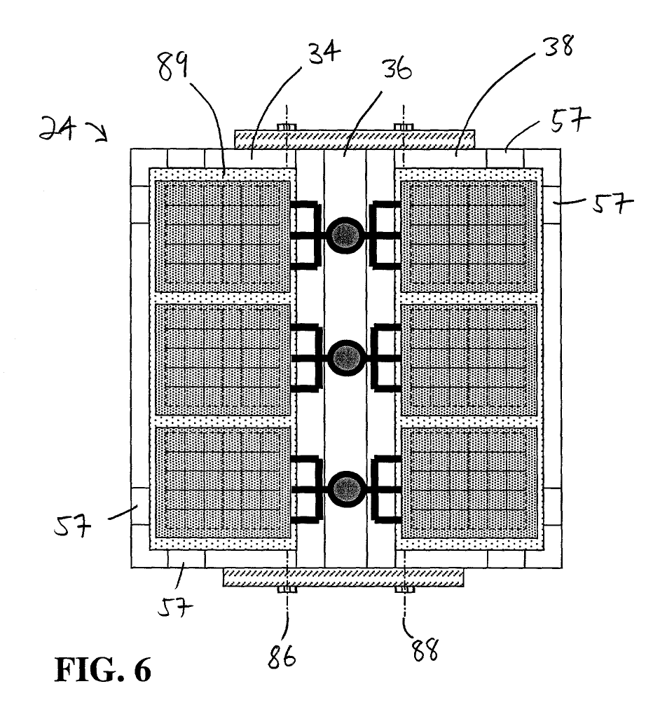

FIG. 6 illustrates electronic assembly 89 inserted into lower degater half 24. The aligning supports 57 provide a volume on top of the lower degater half 24 that the electronic assembly 89 securely occupies. The electronic assembly 89 is secured on top of lower degater half 24 because outer edges of the electronic assembly 89 contact inner edges of the aligning supports 57, thus preventing the electronic assembly 89 from shifting.

FIG. 7 illustrates a support pin assembly 120 including a back wall 121 and an inner sidewall 122, having a radial circumference, forming a volume 124 having a substantially cylindrical shape. The volume 124 contains a support pin 48, a pin ring 126, a spring 128, and a pin stop 130. The support pin 48 has a bottom surface 50. The pin ring 126 has a top surface 134, a bottom surface 136, and an outer surface 138, and is made from a metal, preferably steel. The spring 128 has an upper portion 140 and a lower portion 142, and is made from a tensile metal, preferably steel. The pin stop 130 has a top surface 144, a bottom surface 146, and an outer surface 150.

The support pin 48 and the pin ring 126 include corresponding threads (not shown), allowing the support pin 48 to be securely screwed into the pin ring 126. Providing the support pin 48 and the pin ring 126 with corresponding threads also allows the length that the support 48 extends from the pin ring 126 to be adjustable. Alternatively, the support pin 48 may be friction-fit into a hole (not shown) in the center of pin ring 126. The pin ring 126 is positioned within the volume 124 with its outer surface 138 contacting the inner sidewall 122. However, the pin ring 126 freely moves inside of volume 124, allowing the support pin 48 to extend out from and be pushed into the volume 124, while remaining substantially perpendicular to the lower surfaces 40 and 42 of the upper supports 28 and 32. The top portion 140 of the spring 128 contacts the back wall 121, and the lower portion 142 contacts the top surface 134 of the pin ring 126. The spring 128 biases the upper and lower portions 140 and 142 away from each other such that, contemporaneously, the pin ring 126 and the back wall 121 are biased away from each other. The pin stop 130 is secured inside of the volume 124 such that its outer surface 150 contacts the inner sidewall 122. The pin stop 130 and the inner sidewall 122 include corresponding threads allowing the pin stop 130 to be screwed inside of the volume 124 until the bottom surface 146 is substantially flush with a bottom surface of the upper degater half 22. Alternatively, the pin stop 130 may be friction-fit inside of the volume 124.

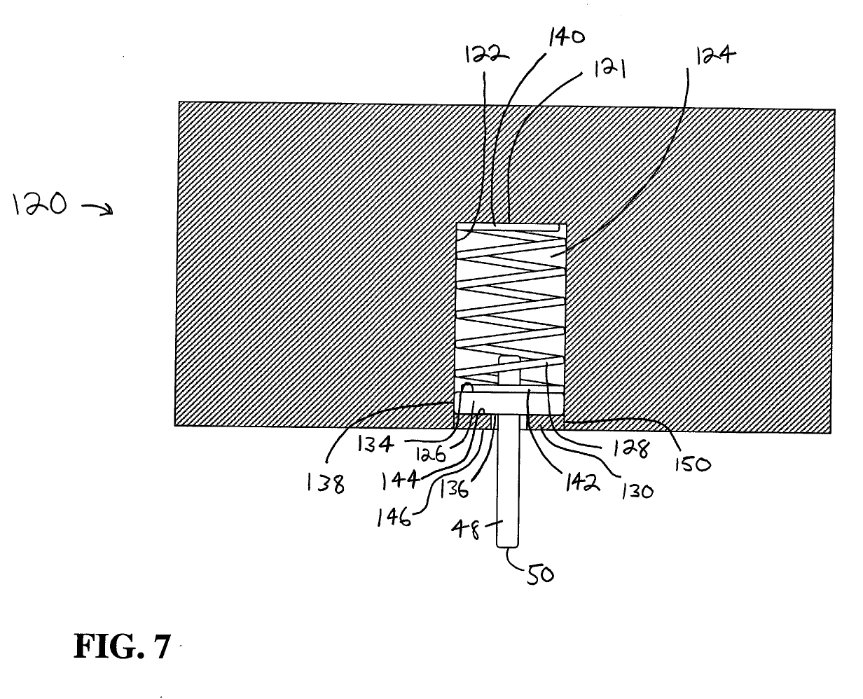

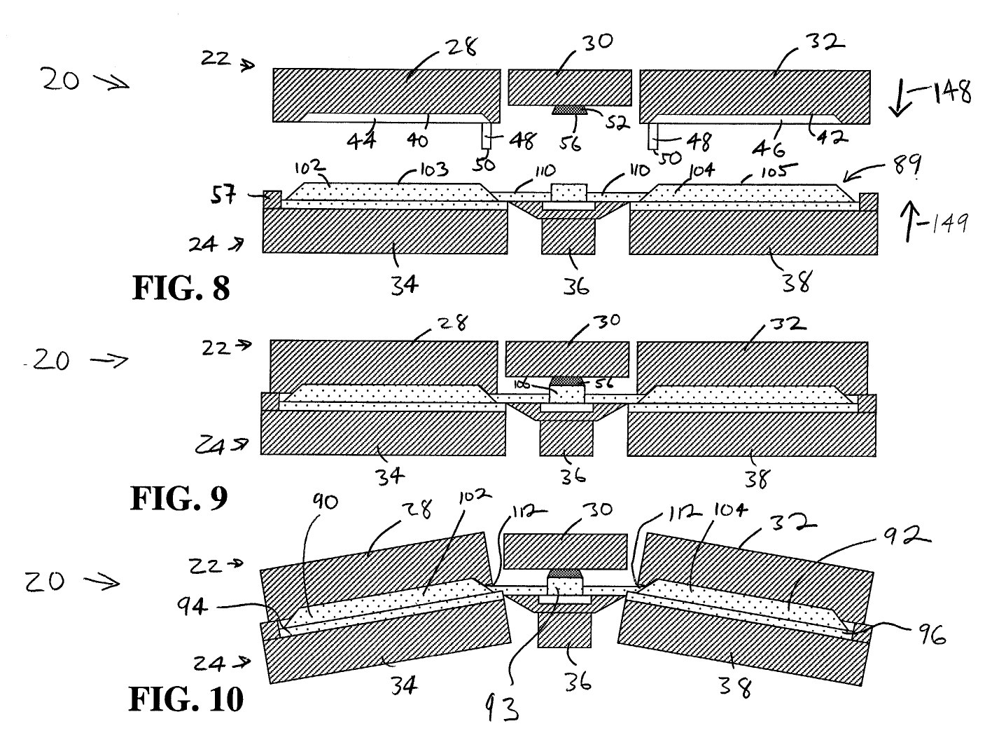

FIG. 8 illustrates the lower degater half 24, the upper degater half 22, and the electronic assembly 89 in combination. In use, the electronic assembly 89 is first positioned on top of the lower degater half 24. The substrates 94 and 96 contact the upper surfaces 53 and 55 of the lower supports 34 and 38 respectively. In addition, the subrunners 110 contact the upper surface 58 of the lower cull support 36. A guide rod assembly (not shown) allows upper degater half 22 to move in a direction 148 and lower degater half 24 to move in a direction 149, thereby moving upper and lower degater halves 22 and 24 toward one another and into a closed position.

FIG. 9 illustrates the degater assembly 20 in a closed position after the upper and lower degater halves 22 and 24 are moved all the way toward one another. The lower surfaces 40 and 42 of the upper supports 28 and 32 contact top surfaces 103 and 105 of the encapsulant bodies 102 and 104, respectively. In addition, the lower portions 56 of the retainers 52 are attached to the culls 106. The lower portions 56 are in the form of cups that suck the culls 106 once contact is made therebetween, thereby securing the culls 106 thereto. Alternatively, suction may be assisted by a vacuum system (not shown) attached to the retainers 52. The volumes 44 and 46 receive only portions of the subassemblies 90 and 92 when the degater assembly 20 is closed. In another embodiment, the volumes 44 and 46 receive all of the subassemblies 90 and 92. Once the degater assembly 20 is in the closed position, it can securely enter a butterfly position.

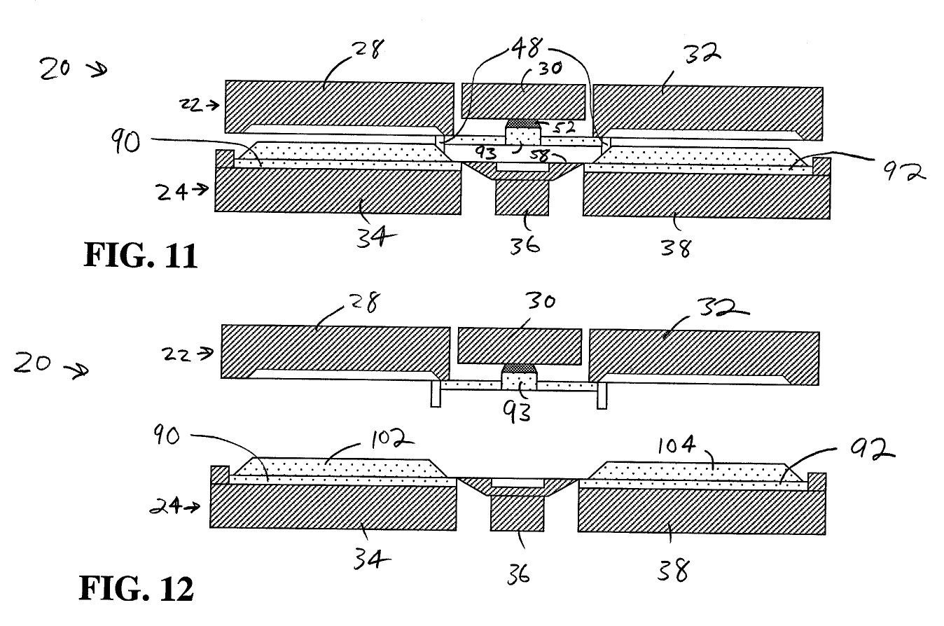

FIG. 10 illustrates degater assembly 20 in a butterfly position. In the butterfly position, the upper supports 28 and 32 and the lower supports 34 and 36 pivot about axes 72, 74, 86, and 88 respectively. The pivoting of the lower supports 34 and 36 bend electronic assembly 89 at the gates 112. The subassemblies 90 and 92 are pivoted by the upper supports 28 and 32 and the lower supports 34 and 36 back and forth until the excess encapsulant pieces 93 are, ideally, completely severed from the encapsulant bodies 102 and 104 and the substrates 94 and 96. However, such back-and-forth pivoting may not completely sever the excess encapsulant pieces 93 from the encapsulant bodies 102 and 104 or from the substrates 94 and 96. Instead, the pivoting may only weaken the bonds between the excess encapsulant pieces 93 and the encapsulant bodies 102 and 104 and the substrates 94 and 96. Subsequently, the degater assembly 20 will proceed to open and move from a closed position to a partially open position, as shown in FIG. 11.

FIG. 11 illustrates the degater assembly 20 with upper degater half 22 partially separated from the lower degater half 24. With the degater assembly 20 in this position, the upper supports 28 and 32 are separated from the electronic assembly 89. However, the bottom surfaces 50 of the support pins 48 remain stationary relative to the lower supports 34 and 38, thereby keeping the subassemblies 90 and 92 against the lower supports 34 and 38. With the support pins 48 securing the subassemblies 90 and 92, the retainers 52 separate the excess encapsulant pieces 93 from the encapsulant bodies 102 and 104 without the subassemblies 90 and 92 being pulled off from the lower supports 34 and 38 as the upper degater half 22 separates from the lower degater half 24. As the upper degater half 22 moves farther away from the lower degater half 24, the excess encapsulant pieces 93 will eventually completely detach from the encapsulant bodies 102 and 104 and from the substrates 94 and 96. Eventually, the degater assembly 20 will reach an open position, as shown in FIG. 12.

FIG. 12 illustrates the degater assembly 20 in an open position. The support pins 48 are no longer contacting any portions of the subassemblies 90 and 92. When the degater is arriving in the open position, the support pins 48 are each allowed to extend out from the volume 124 and away from the back wall 121 of a support pin assembly 120. This occurs because the upper and lower degater halves 22 and 24 are moving away each other (i.e., in the directions 148 and 149, respectively), and the subassemblies 90 and 92 eventually disengage from the bottom surfaces 50 of the support pins 48, thus allowing the support pins 48 to fully extend due to the biasing force provided by a plurality of springs, e.g., spring 128. Accordingly, the support pin 48 is pushed outward from upper supports 28 and 32. In addition, excess encapsulant pieces 93 are freely detached from any portion of the subassemblies 90 and 92.

The pushing back and extending of the support pins 48 will coincide with the movement of the upper and lower degater halves 22 and 24. When the upper and lower degater halves 22 and 24 are partially separated and moving together, the support pins 48 will be gradually pushed back into the upper supports 28 and 32 as the bottom surfaces 50 press against the subassemblies 90 and 92. When the upper and lower degater halves 22 and 24 are partially separated and moving apart, the support pins 48 will be allowed to extend from the upper supports 28 and 32 as the bottom surfaces 50 disengage from the subassemblies 90 and 92.

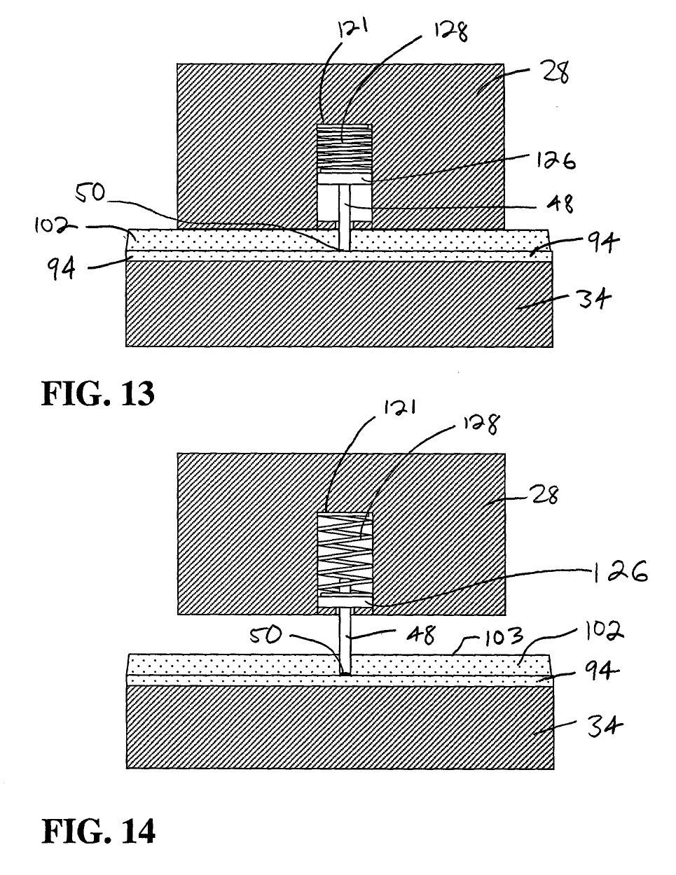

FIG. 13 illustrates the position of a support pin 48 when the degater assembly 20 is in the closed position. When the degater assembly 20 is arriving in the closed position, the support pins 48 are each pushed back into a volume 124 and toward the back wall 121 of a support pin assembly 120. This occurs because the upper and lower degater halves 22 and 24 are moving toward each other (i.e., in the directions 148 and 149, respectively), and the subassemblies 90 and 92 eventually contact the bottom surfaces 50 of the support pins 48, pushing them each back into a volume 124. The spring 128 is more compressed when the degater assembly 20 is in the closed position as compared to when it is in the open position. The upper portion 140 is contacting the back wall 121 while the lower portion is contacting the pin ring 126, thereby biasing the pin ring 126 away from the back wall 121. Accordingly, the bottom surface 50 of the support pin 48 is biased against the top surface of either an encapsulant body or substrate. As illustrated in FIG. 13, the bottom surface 50 of a support pin 48 is biased against the substrate 94 and secures the subassembly 90 against the lower support 34. It will be understood that all of the support pins 48 operate in an identical or similar manner, as described above, securing both the subassemblies 90 and 92 against the lower supports 34 and 38.

When the degater assembly 20 is in the partially open position, the bottom surfaces 50 of the support pins 48 continue to contact the subassemblies 90 and 92. FIG. 14 illustrates the position of a support pin 48 when the degater assembly 20 is in the partially open position. The spring 128 remains compressed and biases the pin ring 126 away from the back wall 121. Accordingly, the bottom surface 50 of the support pin 48 is biased against the top surface 95 of the substrate 94 at locations in between the encapsulant bodies 102. Alternatively, the bottom surface 50 may contact the top surface 103 of an encapsulant body 102. As illustrated in FIG. 14, the bottom surface 50 of the support pin 48 is biased against the substrate 94 and secures the subassembly 90 against the lower support 34. It will be understood that all of the support pins 48 operate in an identical or similar manner, as described above, securing both the subassemblies 90 and 92 against the lower supports 34 and 38.

A degater system 20 having pin assemblies 48 has distinct benefits. During the encapsulation process, liquid encapsulant that enters the gates of the mold can bind to portions of the substrates. Thereafter, when the encapsulant cures, subrunners can adhere to the substrates and will be difficult to remove during the degating process. Difficulties may arise when the excess encapsulant pieces do not fully detach from either the encapsulant bodies or from the substrates prior to the upper and lower degater halves separating from each other. If the excess encapsulant pieces are not fully detached, they will lift the electronic subassemblies off of the lower supports. Eventually, the excess encapsulant pieces will detach due to the weight of the subassemblies; however, the subassemblies can fall back onto the lower supports misaligned. Misalignment can cause problems during later stages of an automated fabrication process.

Another embodiment of the present invention includes a similar arrangement of degater system 20. However, instead of the upper and lower supports securing an electronic subassembly, the upper and lower supports secure the excess encapsulant pieces. Accordingly, the retainers would secure the subassemblies instead of the excess encapsulant pieces. Thereafter, the excess encapsulant pieces would be at least partially severed from the subassemblies by the supports pivoting in a similar manner as described above. When the upper degater half separates from the lower degater half, retainers would separate the subassemblies away from the excess encapsulant material. Contemporaneously, support pins would extend from the upper degater half and secure the excess encapsulant material against the lower supports, thus achieving the same benefits as described below.

While certain exemplary embodiments have been described and shown in the accompanying drawings, it is to be understood that such embodiments are merely illustrative and not restrictive of the current invention, and that this invention is not restricted to the specified constructions and arrangements shown and described since modifications may occur to those ordinarily skilled in the art.

What is claimed is:

1. A degater comprising:
first and second degater halves which are movable relative to one another between a first position wherein the halves are adjacent to one another and a second position wherein the halves are separated, the halves, when in the first position, defining a space between them having separate volumes, one of the volumes being shaped to hold a subassembly including a first electronic component having an encapsulant formed thereon and the other volume being shaped to hold a subassembly including excess encapsulant, and the encapsulant being connected to and at least partially severable from the excess encapsulant while the subassemblies are in the volumes;
a retainer having a first portion secured to the first half and having a second portion securing a first of the subassemblies, and moving the first subassembly with the first half when the halves are moved from the first to the second position; and
a separator secured to the first half and having a first surface contacting a second of the subassemblies, the first surface moving away from the first half when the halves are moved from the first to the second position and biasing the second subassembly away from the first half toward the second half.

2. The degater of claim 1, wherein the excess encapsulant is at least partially severed from the encapsulant of the electronic component when the halves are moved from the first position to the second position.

3. The degater of claim 1, wherein a surface of one of the halves includes a recess being shaped to receive at least a portion of one of the subassemblies when the halves are in the first position.

4. The degater of claim 1, wherein a surface of one of the halves includes aligning supports positioned to support one of the subassemblies when the halves are in the first and second positions.

5. The degater of claim 1, wherein the volumes are adjacent to one another.

6. The degater of claim 1, wherein the excess encapsulant includes a cull and a runner.

7. The degater of claim 6, wherein the encapsulant is formed on all sides of the electronic component.

8. The degater of claim 1, wherein the second portion of the retainer includes a surface that adhesively attaches to the first subassembly.

9. The degater of claim 8, wherein the second portion of the retainer is a suction cup.

10. The degater of claim 1, wherein the separator is a pin which is at least partially retracted into the first half when the halves are in the first position and is at least partially extended out from the first half when the halves are in the second position.

11. The degater of claim 1, wherein a first of the volumes includes the first subassembly, a second of the volumes includes the second subassembly, and a third of the volumes includes a third subassembly having a second electronic device with encapsulant thereon, the encapsulant of the second electronic device being secured to and partially severable from the excess encapsulant of the first subassembly.

12. The degater of claim 11, wherein the first volume is adjacent to the second and third volumes, and the second and third subassemblies are connected by the first subassembly.

13. The degater of claim 1, further comprising a hinge assembly securing the first half to the retainer, the hinge assembly having an axis, wherein the first half can pivot about the axis and relative to the retainer.

14. The degater of claim 1, further comprising a component with first and second portions, the first portion contacting a surface of the first half and the second portion contacting a second surface of the separator, the portions being biased relative to one another.

15. A degater comprising:
first and second supports mutually positionable relative to each other between a first position wherein the supports are adjacent to each other and a second position wherein the supports are separated from each other, the supports, when in the first position, defining a space between them having first, second, and third volumes, the first and second volumes being shaped to hold first and second electronic components respectively, each having encapsulant formed thereon, and the third volume being shaped to hold excess encapsulant, wherein the excess encapsulant attaches the first electronic component to the second electronic component;
a retainer having a first portion secured to the first support and a second portion in the shape of a cup adhesively secured to the excess encapsulant, and detaching the excess encapsulant from the encapsulant of the electronic components when the supports move from the first to the second position;
a plurality of support pins secured to the first support and having surfaces contacting the electronic components when the supports are in the first position, the surfaces extending from the first support and biasing the electronic components against the second support as the supports move from the first to the second position.

16. The degater of claim 15, wherein the first support has first and second portions, the first portion forming the first volume with the second support and the second portion forming the second volume with the second support.

17. The degater of claim 16, further comprising a hinge assembly securing the first and second portions of the first support to the retainer, the hinge assembly having first and second axes, wherein the first portion can pivot about the first axis and the second portion can pivot about the second axis.

18. A method for degating an encapsulated microelectronic device, comprising:
supporting and encapsulated microelectronic device having subassemblies at least partially severable from each other, one of the subassemblies including an electrical component with an encapsulant formed thereon and another of the subassemblies including excess encapsulant, a first support supporting a first side of a first subassembly and a second support supporting a second side of the first subassembly such that the first and second supports are adjacent to one another and the first subassembly is secured therebetween;
securing a retainer, movable with one of the supports, to a second of the subassemblies;
at least partially detaching the first subassembly from the second subassembly;
separating the first and second supports away from each other, the retainer moving with one of the supports; and
biasing a first support member, secured to and movable relative to the first support, against the first subassembly and toward the first support while separating from the second support.

19. The method of claim 18, wherein the detaching includes pivoting the first and second supports, together as a unit, relative to the retainer.

20. The method of claim 19, wherein the excess encapsulant is at least partially severed from the encapsulant of the microelectronic device when the supports are separated from each other.
